(19) United States
(12) Patent Application Publication
(10) Pub. No.: US 2006/0031578 A1
(43) Pub. Date: Feb. 9, 2006

(54) Method of creating and managing a virtual universe

(75) Inventor: Guillaume Pelletier, St German Les Corbeil (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: DOTVISION, Paris (FR)

(21) Appl. No.: 10/497,593

(22) PCT Filed: Dec. 3, 2002
(86) PCT No.: PCT/FR02/04148

§ 371 Date: Jul. 5, 2005

(30) Foreign Application Priority Data
Dec. 3, 2001 (FR) 0115583

(51) Int. Cl. G06F 15/16

(52) U.S. Cl. 709/245

(57) ABSTRACT

The present invention discloses a method of creating and managing a virtual universe, enabling a plurality of users simultaneous and interactive access to the virtual universe via a network. A common system of coordinates is associated with the virtual universe and with virtual spaces contained therein. The method includes defining at least two distinct virtual spaces of the virtual universe. For each distinct virtual space, data is stored on a network server. The data comprises data enabling the distinct virtual space, to be characterized intrinsically, as well as data containing network addresses of virtual spaces adjacent to the respective distinct virtual space.

The present invention relates in general to creating and managing virtual digital spaces.

More precisely, the invention relates to a method of creating and managing a virtual universe, enabling a plurality of users to access the virtual universe simultaneously and interactively via a network.

The invention also relates to a system enabling such a method to be implemented.

Methods and systems of the above-mentioned type are already known.

Thus, it is known to create a virtual universe made up of a virtual space by using digital data to model the characteristics of said space (geometrical boundaries and outlines, appearance, or even local characteristics corresponding to physical conditions such as luminosity, wind conditions, . . . ).

It is also known to make such a virtual space available to users, e.g. by enabling users possessing respective terminals connected to a common network to download into their respective terminals data from a server that is connected to that network, so as to import into each terminal the virtual space that corresponds to said data.

It is also known to enable a user to navigate within the virtual state as imported in this way into the terminal, e.g. by causing a virtual object to move in said space which is stored in the user's terminal.

Such a virtual object is known by the term “avatar”. An avatar thus constitutes a particular virtual object.

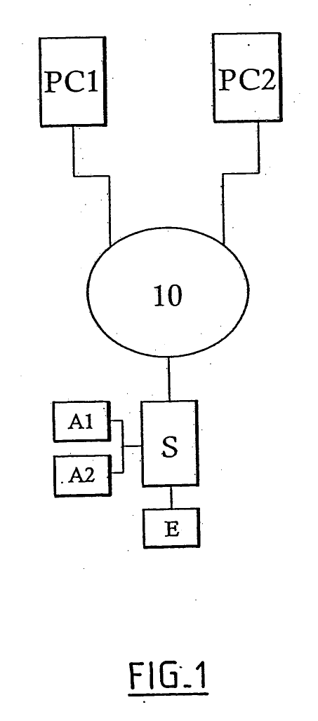

FIG. 1 is thus a diagram of a known system in which two terminals PC1, PC2 associated with respective different users are connected to a common network 10.

The network 10 may be any public or private network. For example it may be the World Wide Web.

A server S is connected to the same network and has stored therein the data of a virtual space E.

The terminals PC1 and PC2 may be any type of digital terminal having memory, processor means, an interface enabling a user to input instructions (e.g. a keyboard), and means for connection to the network 10.

Preferably, the terminals also include a visual interface (of the screen type) enabling a user to visualize the virtual space.

The terminals may thus be constituted by personal computers, however they could be constituted by any type of device satisfying the above criteria (personal digital assistants (PDAs), mobile telephones, games consoles, etc. . . .).

To access the virtual space E, the user associated with the terminal PC1 acts via the network 10 to download data concerning the space E into the terminal PC1.

In this respect, the user has opened a session on the server S.

In addition, means are provided at the server S to create an avatar A1 of the terminal PC1, i.e. a virtual object that can move in the space E.

In association with the avatar A1, the server S stores:
the network address of the terminal PC1 (which address is typically an Internet protocol (IP) address); together with
the coordinates of A1 in the space E.

The space E is associated with a “physical” frame of reference which corresponds to a frame of reference of the kind that enables users to locate themselves in the real work (typically but not in limiting manner, a two-dimensional frame of reference of the (OXY) type or of the (latitude, longitude) type, or a three-dimensional frame of reference of the (OXYZ) type or of the (latitude, longitude, altitude) type).

The coordinates of A1 in E are those which enable A1 to be situated in the space E.

The coordinates of the avatar A1 are thus stored permanently in a memory associated at the server with the network address of the terminal PC1.

By entering suitable instructions on the terminal PC1, the user associated with that terminal can control the action of the avatar A1 (movements in the space E, or other actions), and also changes of state of the avatar.

Resources may also be associated with the avatar A1. These resources may be of any type (e.g. a multimedia object, but also any type of attribute or behavior relationship specific to the avatar), and they can be stored at any location of the network 10.

Each resource is thus identified in the network by an address, typically of the uniform resource locator (URL) type.

Such a URL is stored in association with other data relating to the avatar A1 in the associated memory at the server S.

It is mentioned above that the user associated with the terminal PC1 can control actions and changes of state of the avatar A1 by appropriate instructions.

The user can also see the effects of said instructions on the terminal PC1.

A program of the server that has been loaded on the terminal PC1 together with the data concerning the space E enables the user to visualize the space E.

It is thus possible for the screen of PC1 to display a view of the bird's eye view type in which the user has the impression of flying over certain portions of the space E.

It is also possible, in a variant, to have an “immersive” view in which the user sees “through the eyes” of the avatar.

In all cases, the portion of the space E which is seen by the user is determined by the movements and the attitudes of the avatar.

Everything mentioned above concerning the terminal PC1 and the associated avatar A1 is also applicable to the terminal PC2 and the associated avatar A2.

In all cases, the view made available to the user of a given terminal (e.g. PC1) can also include representations of other avatars, associated with other terminals, with the movements, actions, and changes of state of those other avatars being controlled by other users.

For this purpose, the avatar (in this case A1) associated with the terminal constitutes a “communications channel” from the server to the terminal PC1: on each change that occurs in the space E (introduction or disappearance of an avatar, change in position or state of an avatar, or indeed some other change in the universe, . . . ), the change is indicated by a message from the server S that is sent to the terminals that have opened a session therewith.

Since each terminal is identified by its network address stored in the server S associated with the corresponding avatar, the terminals do indeed receive such messages.

Each user can thus view the virtual space on the terminal, which space includes the other avatars corresponding to the other users.

Each of the users can also control the actions of their own avatar, which can thus interact with the space, with objects in the space, and with the other avatars.

Thus, known systems and methods operating in particular in application of the principles explained above with reference to FIG. 1 enable a plurality of users to share a virtual experience (e.g. for the purposes of a video game, but also for simulation for any purpose, which may be industrial, economic, or other).

However an important limitation associated with those known methods and systems is that generating a virtual space usually requires a large amount of data to be implemented, thereby occupying significant memory space on the server hosting the data corresponding to the space.

This limitation also applies to user terminals which must be capable of storing the data corresponding to the space E that is to be viewed, and in which the users desire to have a virtual experience.

Amongst other things, this limitation can lead to a “physical” limitation on the dimensions of the virtual space in which it is possible for a user to navigate, and/or on the quality of the representation (level of detail, texture, number of avatars—and more generally number of virtual objects—that may be included in the space . . . ).

A system enabling users to have access to a virtual universe is disclosed in the article entitled “Locales: supporting large multiuser virtual environments” by J. W. Barrus et al.

That system implies local relationships between individual virtual spaces, by implementing different local coordinate systems, each individual virtual space having its own coordinate system.

Such an approach does not enable the above-mentioned limitations to be avoided.

An object of the invention is to enable such limitations to be avoided.

Another object of the invention is to make it possible, more generally, to improve the ergonomy of the virtual experience made available to a user.

To achieve these objects, the invention provides a method of creating and managing a virtual universe enabling a plurality of users simultaneous and interactive access to the virtual universe via a network, the method being characterized in that a common system of coordinates is associated with the virtual universe and with the virtual spaces it contains, and in that the method comprises:
defining at least two distinct virtual spaces of said universe;
and for each virtual space storing on a network server, data comprising:
   data enabling said space to be characterized intrinsically; and
   data containing the network addresses of spaces adjacent to said space.

Preferred but non-limiting aspects of the method are as follows:
the virtual universe is subdivided into a hierarchical step of grids;
the data associated with each virtual space can be stored on a respective different server of the network;
the method includes connecting a respective terminal of each user with a universe-managing server, which server includes means for creating an avatar for the user that the user can cause to move in the universe;
each user can move the associated avatar between individual spaces of the virtual universe by entering an instruction to the terminal for moving the avatar or an instruction giving geographical coordinates, the universe management server then serving:
   to make a connection with the server of the target individual space for the movement of the avatar; and
   to send the data corresponding to the target individual space to the user terminal;
said sending of data from the universe-managing server to the user terminal is performed as a function of movement instructions supplied by the user to the terminal;
as a function of the movements of the avatar, the data corresponding to new portions of the individual space that are to be displayed are loaded into the terminal, whereas data corresponding to portions of the space that the avatar has “left” are unloaded from the memory of the terminal;
the user can cause the coordinates of a specific point in an individual virtual space to be stored, and the user can subsequently call said stored coordinates;
in association with the coordinates, there is also stored a network address of a server hosting the data of an individual space whose geographical boundaries contain said coordinates;
following a call to stored coordinates, the method comprises:
   directly calling the server designated by the network address in order to transfer the avatar to the new server; and
   introducing the new avatar into the new space at the desired point;
said storage is performed in association with the avatar, or by storing said information on the terminal; and
the coordinates are stored together with the network address of the server hosting the data of the individual space containing the selected point.

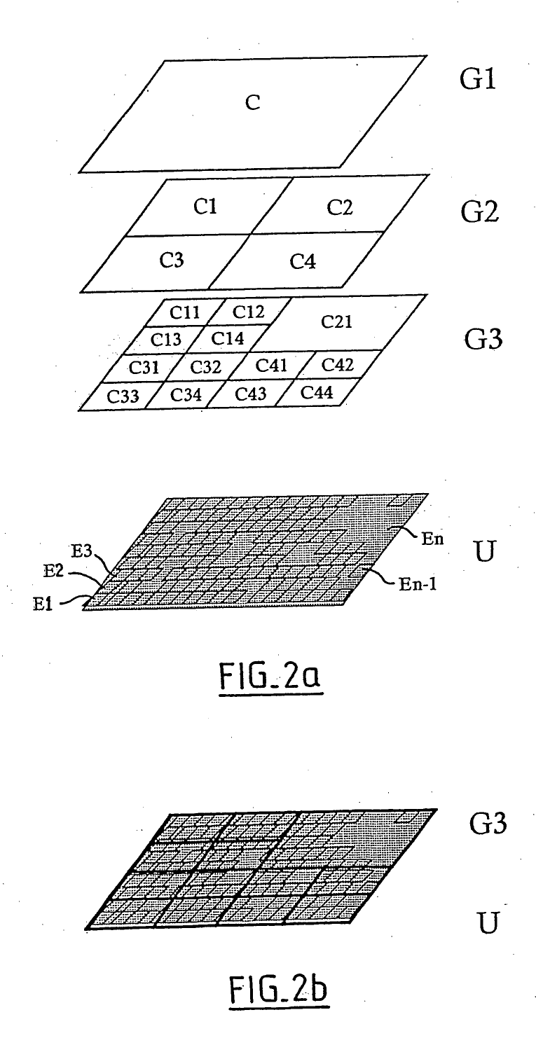

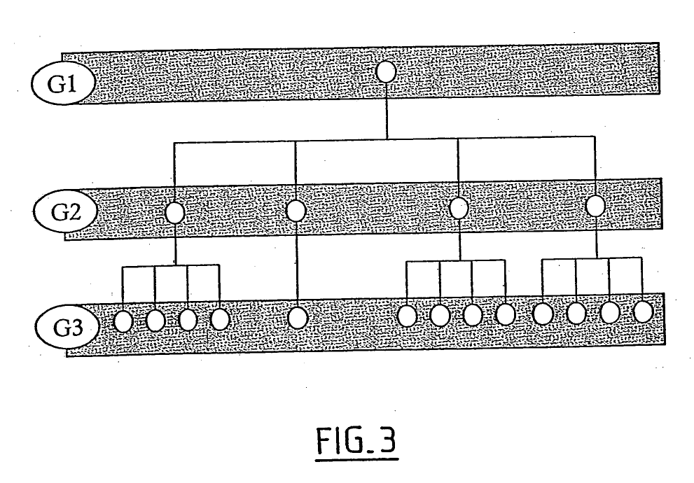

Other aspects, objects, and advantages of the invention appear better on reading the following description of an implementation of the invention, given with reference to the accompanying drawings, in which, in addition to FIG. 1 described above with reference to the state of the art:
FIG. 2a is a diagram showing a general principle of spatial subdivision enabling different virtual spaces of a virtual universe to be associated with spatial coordinates, with the spatial subdivision possibly implementing different levels of subdivision having cells that form a spatial partitioning that is more or less detailed;
FIG. 2b shows the co-operation between one of the above-mentioned subdivision levels with the virtual universe, this co-operation enabling the virtual spaces of the virtual universe to be identified spatially; and
FIG. 3 is a tree diagram organized in the levels mentioned above, in which the nodes of the diagram correspond to cells at the various above-mentioned levels of subdivision, and in which the network addresses corresponding to servers are associated with certain nodes.

With reference initially to FIG. 2a, there is shown very diagrammatically a virtual universe U which, in the present case, is two-dimensional.

It is specified that although the description below is made with reference to such a two-dimensional universe, and makes use of two-dimensional grids (where the role of such grids is explained below), the invention is applicable to virtual universes that are three-dimensional, and more generally of an arbitrary number of dimensions.

It is also specified that the description below is based on certain elements of the description given above of the state of the art.

Thus, in this case likewise, there is a configuration in which different users associated with respective terminals seek to access a virtual space via a common network.

As shown in FIG. 2a, the universe U comprises a plurality of virtual spaces E1, E2, . . . , En. These spaces are referred to below as “individual” spaces, and they are designated collectively by the reference E1.

Each space E1 is included in the universe U.

The spaces E1 may form a subdivision of the universe U that is “spatial” (or “geographical”, these two terms being equivalent in the presence text), i.e. the union of the spaces E1 is equivalent to the universe U. This configuration is shown in FIGS. 2a and 2b.

The union of the spaces E1 may also be included in the universe U without being equal thereto.

In which case, certain zones of the universe U do not correspond to any individual space. These zones are referred to as “dead” zones, and no user can penetrate therein.

It is thus possible to define an arbitrary subdivision of the universe U or, more generally, an arbitrary distribution of the individual spaces in the universe U.

More particularly, the frontiers of each space E1 may be of arbitrary shape and orientation—there is no need for the frontiers of the spaces E1 to be aligned in any particular direction. Each space E1 can thus have arbitrary frontiers and dimensions.

It is specified that two individual spaces cannot overlap so as to have portions in common.

Each individual space is defined by:
its spatial frontiers (a description is given below of the data associated with the frontiers of each space, comprising the network addresses of the two spaces that are to be found on either side of the frontier);
and by environment parameters that are “local” to the space, which make it possible to characterize intrinsically for the space:
   the texture and appearance of the various regions of the space;
   conditions, such as wind or sunlight, for example, for a physical representation; and
   more generally, behavioral relationships for the various virtual objects that might be found in the space.

For each space, the sum of the data corresponding to the definition of its frontiers (frontier headers which are defined in detail below), and the data corresponding to the local environment parameters of the space forms that which is referred to as “space data”.

For each space, the space data is stored on a network server, it being possible for the data of each space to be stored on a respective network server. This aspect is returned to below.

In any event, each server hosting the data of a space E1 has a network address (of the IP address type).

FIG. 2a shows a plurality of grids G1, G2, G3 above the universe U.

Each of the grids corresponds to a different partitioning of the universe U. These partitions are defined by cells associated with each grid.

More precisely, in the example of FIG. 2a, the grid G1 defines a general context corresponding to the spatial frontiers of the universe U. This grid G1 thus has only one cell, referenced C.

It is recalled that the grids have the same dimensions as the universe U—in a three-dimensional universe, these grids are thus in the form of three-dimensional matrices.

Although the universe U is plane in the simplified example of FIGS. 2a and 2b, this is not essential.

The universe U may thus be of arbitrary shape (an optionally regular curved surface, and more generally a universe of arbitrary shape and dimensions).

Whatever the size and shape of the space U (and thus of the grids G1, G2, and G3), a common single system of spatial coordinates is associated with the grid (and as described below likewise to the universe and to the individual spaces it contains).

In this respect, it should be observed that the invention adapts an approach that is completely opposite from that disclosed in the article by J. W. Barrus et al. entitled “Locales: supporting large multiuser virtual environments”.

The common system of spatial coordinates is used for defining cell boundaries (and also, as explained below, to enable users to locate themselves in the universe U and in the spaces it contains).

For a two-dimensional space, it is thus possible, for example, to use coordinates of the (X,Y) type, or of the (latitude, longitude) type or indeed coordinates making use of a time zone concept (like the UTM terrestrial frame of reference).

The grid G2 defines a partitioning of the single cell C of the grid G1: four cells C1, C2, C3, and C4 are thus defined.

It is not essential in any way for the cell C to be subdivided into four cells that are equal and regular: the grid G2 may be set up to partition the cell C in any manner whatsoever.

The grid G3 in turn corresponds to a union of a partitioning of cells different from G2.

G3 therefore corresponds to a partitioning different from G1, being implemented at a finer level of detail: G3 thus corresponds to a kind of “zoom” onto G1.

It should be observed at this point that the partitioning of G3 is not regular (in the same manner as stated above, that the partitioning of G2 need not necessarily be regular).

Although each of the cells C1, C3, and C4 of G2 is partitioned into four respective cells in G3, the cell C2 in G2 is not partitioned in G3.

The grid G3 thus comprises:
four cells C11, C12, C13, C14 which form a partitioning of the cell C1 in grid G2;
four cells C31, C32, C33, C34 which form a partitioning of the cell C3 in grid G2;
four cells C41, C42, C43, C44 which form a partitioning of the cell C4 in grid G2;
a cell C21 which has the same boundaries as the cell C2 in grid G2.

The grids G1 to G3 thus form an ordered set of grids made up on the principle of “quadtrees” or “octrees” for example, with an example of such ordering being described at the address: <http://www.andrew.cmu.edu/user/sowen/topics/octree.html>
the grid G1 is a “high level” grid which defines the external frontiers of the universe that is to be made available to users;
the grid G2 is a grid at an immediately lower level whose cells “zoom” onto certain portions of the grid G1 so as to define cells in greater detail (in the example of FIG. 2a, this zoom is performed using four equal quarters—however any distribution of the space corresponding to the grid G2—and thus to the universe U—is possible); and
the grid G3 is a grid at a still lower level, defining cells that are even more detailed.

In the invention, it is thus possible to define a set of grids covering the same space, with:
an arbitrary number of levels. The greater the number of levels, the higher the level of detail in the grid of the lowest level (G3 in FIG. 2a) for at least certain portions of the universe U covered by the grid; and
arbitrary rules for partitioning the space at each level (which rules are defined by using the selected coordinate system). It is possible to partition a given cell of a grid in any desired manner, so as to constitute the corresponding cells of the lower level grid.

Each cell at a given level can thus be partitioned or not partitioned in the lower level grid. Thus, certain zones of the universe U may be covered by cells that define a very high level of detail, whereas other zones of the universe are not associated with any cell of small dimensions.

In any event, the ordering of the grids defines a tree structure, with nodes corresponding to the cells.

Such a tree structure is shown diagrammatically in FIG. 3.

This tree structure shows the cells associated with the three grids G1 to G3 in the form of nodes. The names of the grids are marked in association with each of the corresponding levels of the tree structure.

Returning to FIG. 2b, the universe U is shown together with its individual spaces, with the lowest level grid being superposed thereon (specifically G3—the thickness of the boundaries of the cells in G3 being exaggerated to make them show up more clearly).

An important function of the grids is to enable each individual space E1 to be located in the selected system of spatial coordinates.

Starting from a situation in which coordinates are available (e.g. a (longitude, latitude) pair), it is possible to move down through the FIG. 3 tree structure to identify the lowest level cell containing the point that corresponds to said coordinates.

Additional information is associated with the nodes at the lowest level in the FIG. 3 tree structure (nodes which correspond to cells having the greatest level of detail in a given zone of space, referred to as the “leaves” of the tree structure—where, for simplification purposes, the leaf, the associated cell, and the corresponding node of the tree structure are taken as being equivalent in the text below).

More precisely, in association with each leaf, there are stored parameters associated with those individual spaces of the universe U whose spatial positions in the universe U are such that at least a portion of an individual space extends over a zone covered by the leaf.

For each individual space covered at least in part by a leaf, the following are stored in association with the leaf:
an identifier for the individual space;
the network address of the server hosting the data for this individual space; and
information about the frontiers of the space. This information is in the form of a header corresponding to each segment of the frontier of the space (each frontier segment of the space being parametrized by an equation using the defined coordinate system). Each header corresponding to a frontier segment comprises:
   the geographical definition of the frontier segment (the equation for the segment in the coordinate system); and
   information enabling each of the two individual spaces that are to be found on either side of the frontier segment to be identified. This information preferably comprises the two network addresses of the two servers where the data for the two respective spaces is stored.

The universe U may be a space of arbitrary dimension, and the example described in detail herein with reference to a universe U having two dimensions is not limiting in any way.

Thus, in general, for a universe U of dimension N, each header corresponding to a frontier segment comprises, in addition to the geometrical definition of the frontier segment, information enabling each of the individual spaces adjacent to the segment to be identified (this information thus comprising the network addresses of each of the servers storing the data of the respective spaces, where the number of servers is thus not limited to two. Nevertheless, it is specified that in a variant of the invention, the header does not contain directly the network addresses of the adjacent individual spaces; in which case the header contains information enabling said network addresses to be accessed).

The above-mentioned data is stated above to be stored in association with the leaf corresponding to the lowest level grid.

More precisely, in the tree structure of FIG. 3, each leaf is associated with a respective address of the network, which is the network address where said data associated with the leaf is stored.

The data of each leaf can thus be stored on an individual server having an address that is different from the addresses of the other servers corresponding to the other leaves.

In a variant, some of the server addresses for the data of different leaves can be the same (a plurality of leaves may have their data stored on the same server).

It is even possible to store the data of all the leaves on the same server. The distribution of leaf data between different servers is a question of optimizing storage, and consequently of optimizing data traffic.

This distribution is thus determined by the manager of the universe (the person or group of people who define the universe and manage its operation).

The entire structure described above in the context of the invention needs to be parametrized by the manager of the universe. In particular the following need to be parametrized:
the universe U (with its frontiers and its associated system of spatial coordinates);
the individual spaces E1 with their frontiers and all of their data, and also the server(s) hosting said data and the associated network address(es);
the tree structure of the spatial partitioning grids, and also the partitioning associated with each level; and
the network addresses for the leaf data.

In addition, each node of the tree structure (i.e. each cell in all of the grids G1, G2, G3) may itself be associated with a network address, even if it is not a lowest level node (a leaf).

Such an address is referred to as an “intermediate” node address.

This makes it possible on a server of said network address to store characteristics applicable to all of the cell subordinate to the node.

By way of example, such characteristics may be “physical” conditions (sunshine, wind, . . . ), or any relationship applicable to the virtual objects that might be found in a space covered by the cell (which relationship may apply to certain objects only).

In addition, the definition of an intermediate node also makes it possible for a user to move within the universe U at a “higher level” (this aspect is described in greater detail below).

Starting from a situation in which a user associated with a terminal seeks to connect with the virtual universe U, the user must begin by connecting to a network server hosting a program for managing the universe U, in order to open a virtual session in the universe U.

For this purpose, the user knows the network address of said server.

Such a server is referred to herein as a “universe-managing server”. For the user it constitutes an “entry gateway” into the universe U.

The universe-managing server to which the user is connected includes means enabling it to connect with each of the servers hosting the data for the various individual spaces Ei.

When the user makes a connection to the universe-managing server, the management program creates an “avatar” for the user, i.e. a virtual object that the user is going to be able to move in the universe U.

The geographical coordinate system of the universe U is the only frame of reference known to the user's terminal, with the network addresses of the various servers corresponding to the various individual spaces being unknown to the terminal: the user need know only one network address, the address of the universe-managing server with which the user seeks to make a connection.

Thus, when the user seeks to move the avatar in the system of geographical coordinates of the universe U, the user inputs an instruction to the terminal for moving the avatar (a dynamic movement instruction—typically corresponding to a speed vector in the universe U), or an instruction in the form of geographical coordinates (an instruction specifying the coordinates in the universe U where the user seeks to situate the avatar).

Thereafter, it is the universe-managing server that manages the following:
making a connection with the server of the individual space identified by the movement of the avatar (continuous displacement by crossing the frontier following a dynamic movement instruction, or displacement that can be point-to-point displacement when a change of coordinate instruction is used); and
sending the data corresponding to the specified individual space to the user terminal (with this being done making use of the “streaming” type techniques for continuous downloading that are mentioned below).

It is possible to provide an arbitrary number of universe-managing servers to implement the invention, and the user can connect to any one of these universe-managing servers for the virtual experience.

Each universe-managing server may also be a network server that is associated with an individual space.

Conversely, each network server which stores the data of an individual space may be a universe-managing server—i.e. the server has loaded therein the program for managing the universe U, thus enabling the movements, actions, and changes of state of user avatars to be managed in the various different individual spaces of the universe U.

Several options are made available to a user seeking to connect to the virtual universe U via a universe-managing server:
in a first variant implementation of the invention, the user cannot “force” a geographical address within the system (i.e. the spatial coordinates of the “virtual location” where the user seeks to position an avatar in the universe U).

In this variant, it is thus the universe-managing server to which the user makes the initial connection that imposes a geographical context (this imposed geographical context typically corresponding to the individual space associated with the universe-managing server in question).

Still more precisely:
either the user penetrating into said geographical context imposed by the universe-managing server to which the user made the original connection must necessarily have an avatar penetrate into the virtual universe U at a predefined entry point or “origin” that is imposed within said geographical context; or else
when the user has a profile stored in the universe-managing server to which the user has made a connection, the avatar of the user can recover the data of that profile.

In which case, the avatar can penetrate at a location specific to the user, and with a state and conditions that are likewise specific: for example, a fixed origin location may be allocated to the user, or the avatar may penetrate into the universe U at a geographical location corresponding to the last movement made by the user in the virtual universe U on that user's most recent connection;
in a second variant implementation of the invention, it is possible to allow a user to “force” geographical coordinates on making first connection to a universe-managing server.

In this second variant implementation of the invention, the initial coordinates may be supplied automatically by a device of the global positioning system (GPS) type, connected to the network (via the terminal, or else the GPS itself constitutes the terminal).

Under such circumstances, the initial coordinates may be the real coordinates at which the user is located (for a universe U representing the surface of the earth, for example).

In order to implement this second variant, the user must thus supply the universe-managing server, via the user's terminal, with the initial spatial coordinates of the virtual location at which the user seeks to cause an avatar to penetrate into the universe U.

As a function of these initial coordinates provided by the user, the universe-managing server to which the user is connected undertakes a search in the grid tree structure to identify the leaf containing the initial coordinates.

In order to undertake this search, the universe-managing server can use any known technique.

In particular, it can implement one of the following two techniques:
in a first technique, the universe-managing server delivers the network address of the highest level grid cell C to the user's terminal (it being mentioned above that cells that are not leaves can have intermediate node addresses).

In which case, the terminal makes the connection directly to said address and the search is continued with the initial coordinates: the server associated with the cell C also receives the initial coordinates, and using a program loaded on all of the servers of the system it determines which of the lower level cells contains the corresponding point in the universe (for this purpose, the intermediate node addresses of lower level cells representing the partitioning of the cell C are known to the server associated with the cell C).

The intermediate node address of the selected lower level cell is then transmitted to the user terminal, which makes a connection directly to the server at said address.

The process continues downwards through the levels of the tree structure with the user terminal making connection in succession to the servers of intermediate node addressees of decreasing level until it makes a connection to the server corresponding to the looked-for leaf.
Alternatively, and in a second technique, the universe-managing server itself undertakes the search for the terminal, by calling that one of the servers associated with an intermediate node address that corresponds to the lower level node containing the initial coordinates, said server itself selecting a lower level server, etc. . . . until the network address of the looked-for leaf is identified which is transmitted to the terminal.

The terminal then makes a connection directly with said address.

Once connected to the server associated with the looked-for leaf, the user's terminal sends the initial coordinates to said server.

As a function of these initial coordinates, the server associated with the leaf identifies the individual space which contains the point corresponding to said initial coordinates.

As mentioned above, the characteristics of the individual spaces that are covered at least in part by the leaf—including the frontier equations—are stored in association with the leaf on the server associated with that leaf.

The server associated with the leaf can thus identify the individual space containing the point corresponding to the initial coordinates.

It is also stated above that the characteristics of the frontier of each space are stored in association with the network address hosting the data of that space.

Thus, once the looked-for individual space has been identified, the terminal knows the network address for the individual space (this address being transmitted to the terminal by the leaf server).

Thereafter, the terminal connects to the server corresponding to the network address of the individual space.

In a variant, it is possible for the terminal to be remain connected solely to the universe-managing server throughout the session, with the universe-managing server itself making connections to the called individual space servers.

In both cases, the server then creates an avatar for the user, as in the state of the art described in the introduction to the present text.

That which is stated above is applicable not only to introducing the avatar at a desired “location”, but also to performing point-to-point displacement of the avatar—i.e. non-continuous displacement in the geographical frame of reference.

In a variant, it is possible that an avatar that has already been created by the user has been stored by the universe-managing server (as an avatar “cookie” which records the characteristics and the properties of the avatar)—in which case the data for the avatar can be loaded automatically into the server corresponding to the network address for the individual space.

The user terminal also downloads from the server associated with the individual space data concerning that individual space, in a manner that is similar to that which occurs in the state of the art.

Nevertheless, it should be observed that in an advantageous variant of the invention, the terminal does not load all of the data for the individual space into its own memory (as is the case for known systems in the state of the art).

In contrast, in the invention, the terminal loads only the data needed for reconstructing those portions of the individual space that need to be visible to the user (with the dimensions of such portions varying depending on the type of view—e.g. a bird's eye view or an immersive view), and depending on the position of the avatar: only those portions that surround the avatar are loaded (within a radius that needs to be defined).

In this respect, and depending on the displacements of the avatar, the data corresponding to new portions of the individual space that need to be viewed will be downloaded by the terminal.

Simultaneously, data corresponding to portions of the space that the avatar has “left”—i.e. that user is no longer supposed to be able to view—is unloaded from the memory of the terminal.

This disposition for loading continuously known as “streaming” enables the performance of the system to be improved.

The fact that the streaming is controlled by the movements of the avatar, themselves controlled by the user via the terminal, causes the system to be more reactive and more ergonomic.

The operation of the server associated with the individual space in which the avatar has been created is otherwise similar to the operation described in the introduction concerning state of the art systems (moving in space, viewing other avatars, and interaction with the space and with the other avatars . . . ).

It is the server associated with the individual space that handles avatar movements under the control of the user (still as in the above-described state of the art).

When in the course of making its movements the user's avatar reaches a segment of the frontier of the individual space in which it is to be found, the invention enables the avatar to continue moving instead of “bumping into” the frontier of the space as occurs in known systems.

As mentioned above, the data for the space includes the network addresses of two individual spaces located on either of each frontier segment, so the server associated with the individual space that the avatar is in the process of leaving has available the network address of the server associated with the individual space situated on the other side of the frontier.

The server associated with the individual space that the avatar is in the process of leaving thus transmits:
to the user terminal (whose network address is known in association with the avatar)
   the spatial coordinates of the avatar;
to the server associated with the individual space situated on the other side of the frontier,
   a connection request to authorize connection of the terminal; and
   the state parameters of the avatar (coordinates of the location where the frontier is being crossed, speed and direction of the movement, possibly other state parameters . . . ), so that the server associated with the new individual space handles penetration of the avatar in continuity. These parameters are transmitted using conventional protocols and formats (XML®, serialization).

The user's avatar is then created in the “new” individual space situated on the other side of the frontier, and the avatar moves in this new individual space, in which it can interact with other avatars in said space, and also with the various virtual objects that exist in this new space.

The avatar created in this way inherits the entry coordinates, the dynamic parameters, and possibly also other state parameters from the “old” avatar which can itself be destroyed from the memory of the server for the “old” individual space.

The avatar may be created in the new space, being stored therein together with the network address of the user's terminal: as a result, the avatar takes the initiative of sending a change of individual space message to the terminal.

The user has the illusion of continuing to direct the same avatar while changing individual space (where such a change of space can be entirely imperceptible for the user).

It should be observed, as mentioned above with reference to the state of the art, that avatars can also be associated with resources that are specific thereto.

These resources remain stored at a network location that remains fixed, and that is identified by a URL network address (or a geographical address) that is stored permanently with the avatar in the server corresponding to the individual space in which the avatar is located.

It can thus be seen that the invention enables users not only to connect via a common network to share a virtual experience, but also to pass from one individual space to another without any spatial limitation.

Data concerning the various individual spaces can be distributed over an arbitrary number of servers, with the dimensions of the universe made available to users being unlimited.

The invention provides means for sharing network addresses of these various servers starting from a “geographical” distribution key, with the coordinates used in the universe U possibly being of any type involving natural and intuitive coordinates.

It is also possible to implement the invention so as to enable a user to change individual space “at high level”.

This option is advantageous for “point-to-point” movements.

A user located in an individual space may seek to move the avatar into some other individual space situated far away (using a “distance” based on the geographical coordinate system used).

For example, a user may seek to move from Paris to San Francisco in a universe U that corresponds to the surface of the earth.

For this purpose, the user can send an appropriate command to the server for the space in which the user's avatar is located indicating that the user wishes to perform “high level” movement.

The server associated with the space in which the avatar is located processes such a request in the same manner as crossing a frontier—the only difference with the explanation given above concerning crossing a “conventional” frontier, being that in this case the server to which the data associated with the avatar is to be sent, which server will in turn create a new corresponding avatar, is a server at an intermediate node situated “above” the starting space in the tree structure.

The avatar can thus be transferred between intermediate nodes at the same level, said intermediate nodes not corresponding to individual spaces but to cells at a certain level of the grid, enabling the avatar to be “moved” through the space using large steps in that space.

It is also possible to for the user terminal to store the coordinates of a specific point in an individual virtual space, in association with the avatar, or to store said information in the terminal.

This storage operation is controlled by an appropriate instruction which the user enters via the terminal.

In all cases, the coordinates are stored with the network address of the server hosting the data of the individual space whose geographical boundaries contain the coordinates of the selected point.

The storing of such data (coordinates+network address of the corresponding server) enables a “bookmark” to be established to which the user can refer at any moment in order:
to cause a direct call to be made to the server specified by the network address, which call is performed by the universe-managing server to which the user is connected, thereby “transferring” the avatar to the new server (or more precisely causing an avatar to be recreated in the new server, which avatar inherits the parameters of the old avatar); and
to introduce the new avatar in the new space at the desired point.

When the movements of a user's avatar are restricted to within a given individual space, it is possible to set up bookmarks that are simplified, comprising only the geographical coordinates of the associated point.

Under such circumstances, there is no need to store a network address for a server other than the universe-managing server to which the user normally makes a connection.

1. A method of creating and managing a virtual universe enabling a plurality of users simultaneous and interactive access to the virtual universe via a network, wherein a common system of coordinates is associated with the virtual universe and with virtual spaces contained therein, the method comprising:
defining at least two distinct virtual spaces of said virtual universe; and
for each distinct virtual space, storing data on a network server, the data comprising:
data enabling said distinct virtual space, to be characterized intrinsically; and
data containing network addresses of virtual spaces adjacent to said respective distinct virtual space.

2. A method according to claim 1, wherein each distinct virtual space is defined by its spatial frontiers and by environmental parameters local to the respective distinct virtual space.

3. A method according to claim 1, wherein the data stored for each distinct virtual space further comprises:
an identifier for the distinct virtual space;
a network address of the network server hosting the data of said distinct virtual space; and
information concerning spatial frontiers of the distinct virtual space.

4. A method according to claim 3, wherein said information concerning the spatial frontiers comprises a header corresponding to each frontier segment of the distinct virtual space, each header comprising:
a geometrical definition for each of the frontier segments; and
information enabling the distinct virtual spaces on either side of each frontier segment to be identified.

5. A method according to claim 4, wherein said information enabling the distinct virtual spaces located on either side of each of the frontier segment to be identified comprises network addresses of two servers on which the data for the distinct virtual spaces located on either side of each frontier are stored.

6. A method according to claim 1, wherein the virtual universe is partitioned in a hierarchical set of grids each of the grids corresponding to a different partitioning of the virtual universe.

7. A method according to claim 1, wherein the data associated with each distinct virtual space can be stored on different servers within the network.

8. A method according claim 1, wherein the method further includes connecting a respective user terminal with a universe-managing server, the universe-managing server including means for creating an avatar for each of the users, wherein each user can cause an associated avatar to move in the virtual universe.

9. A method according to claim 8, wherein each user can move the associated avatar between individual spaces of the virtual universe by entering an instruction to the respective user terminal for moving the associated avatar or an instruction giving geographical coordinates, the universe management server then:
making a connection with a server of a target individual space for the movement of the associated avatar; and
sending the data corresponding to a target individual space to the respective user terminal.

10. A method according to claim 9, wherein sending the data from the universe managing server is performed as a function of movement instructions supplied by one of the users to the respective user terminal.

11. A method according to claim 10, wherein, as a function of the movement of the associated avatar, the data corresponding to new portions of the target individual space that are to be displayed are loaded into the respective user terminal, and data corresponding to portions of the space that the associated avatar has “left” are unloaded from a memory of the respective terminal.

12. A method according to claim 1, wherein a user can cause the coordinates of a specific point in an individual virtual space to be stored, and the user can subsequently call said stored coordinates.

13. A method according to claim 12, wherein a network address of a server hosting the data of an individual space whose geographical boundaries contain said coordinates is stored in association with said coordinates.

14. A method according to claim 13, wherein following a call to the stored coordinates, the method further comprises:
directly calling the server designated by the network address in order to transfer an avatar to a selected server; and
introducing the avatar into a new virtual space at a selected point.

15. A method according to claim 14, wherein storing the coordinates is performed in association with the avatar or by storing information on a user terminal.

16. A method according to claim 13, wherein the coordinates are stored together with the network address of the server hosting the data of the individual space.
